(19) United States
(12) Patent Application Publication
(10) Pub. No.: US 2005/0041360 A1
(43) Pub. Date: Feb. 24, 2005

(54) Systems and methods for achieving low power standby through interaction between a microcontroller and a switching mode power supply

(75) Inventor: David A. Dettweiler, Newnan, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: E.G.O. North America, Inc.

(21) Appl. No.: 10/854,733

(22) Filed: May 26, 2004

Related U.S. Application Data
(60) Provisional application No. 60/497,021, filed on Aug. 20, 2003.

(51) Int. Cl. H01H 9/00

(52) U.S. Cl. 361/160

(57) ABSTRACT

An embodiment of the present invention discloses using an on-board microcontroller typically found on a control board or power supply board to momentarily toggle a switching mode power supply off and on. In one embodiment, the power consumption of the circuit is lowered by allowing the power supply and other circuit components to shut down while using a capacitor to provide reserve power to the microcontroller. In another embodiment, the microcontroller is also placed in a low power consumption mode for a predetermined period of time, which decreases the power requirement of the microcontroller and effectively lengthens the amount of time the other circuit components can be shut down. As described herein, this circuitry required to achieve this lower power state is minimal in comparison to known systems and, in one embodiment, requires an optoisolator (or alternatively, a transistor), a resistor and a capacitor.

### RELATED APPLICATIONS

This application claims benefit of U.S. provisional patent application No. 60/497021, filed Aug. 20, 2003.

### FIELD OF THE INVENTION

The present invention relates generally to methods and systems that reduce power consumption in electronic devices. More particularly, circuits are described incorporating a microcontroller and switching mode power supply to achieve a low power standby mode in a household kitchen appliance.

### BACKGROUND OF THE INVENTION

In recent years, the phenomenon of energy wasted from the standby power mode in electrical equipment has become a significant focus of policies directed to energy conservation. Various groups, corporations, as well as various governmental organizations, are exploring ways to reduce standby power consumption in commercial and residential products. In fact, many policies directed to standby power efforts are already in place and apply to specific types of products such as personal computer, televisions and video-cassette recorders. Manufacturers are actively pursuing alternative solutions to reduce the standby power consumption of the next generation of appliances to a standby power level lower than one Watt.

One approach to achieving a low standby power state is to use a relay or a similar device to physically disconnect non-essential circuits from the power supply during the standby state, thereby leaving a control circuit only partially functional. This approach is referenced in U.S. Pat. No. 6,414,864 to Hoshi wherein a separate power supply and microcontroller are used to operate a relay or other switching device to disable the main power supply to the unit. This approach, however, involves a significant amount of expense in that it requires an additional power supply from the main power supply being disabled, as well as a microcontroller to operate the relay.

Other techniques for reducing power supply consumption have focused on reduction of power to non-essential circuits, but such approaches have not focused on reduction of power consumed in the power system, which can consume non-trivial amounts of power, even if the non-essential circuits are in a power standby mode.

A recognized need therefore exists in the industry for a low cost solution to achieving a lower rate of power consumption in a standby mode.

### SUMMARY OF THE INVENTION

One embodiment of the present invention discloses using the on-board microcontroller typically found on a control board or power supply board to momentarily turn off a switching mode power supply, placing it in a standby mode. In another embodiment, the power consumption of the circuit is lowered by allowing the power supply and other circuit components to shut down while using a capacitor to provide reserve power to the microcontroller. In another embodiment, the microcontroller is also placed in a sleep mode for a predetermined period of time, which decreases the power requirement of the microcontroller and effectively lengthens the amount of time the other circuit components can be shut down.

### BRIEF DESCRIPTION OF THE DRAWINGS

Having thus described the invention in general terms, reference will now be made to the accompanying drawings, which are not necessarily drawn to scale.

FIG. 1 is a high-level block diagram of one embodiment of a switching mode power supply that uses a microcontroller to provide a control signal in order to turn off the a switching power supply and certain circuit components during idle periods in accordance with the principles of the present invention.

FIG. 2 is one embodiment of a diagram of a reduced power consumption circuit in accordance with the principles of the present invention.

FIG. 3 is a graph of the prior art showing the rate of power consumption of a typical control circuit.

FIG. 4 is a graph that shows the rate of power consumption of a reduced power consumption circuit in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Using systems and processes described herein, the present invention generally describes a reduced power consumption circuit that reduces power usage while in a standby mode by shutting down a power supply and other circuit components, while maintaining operation of a microcontroller through capacitive reserve.

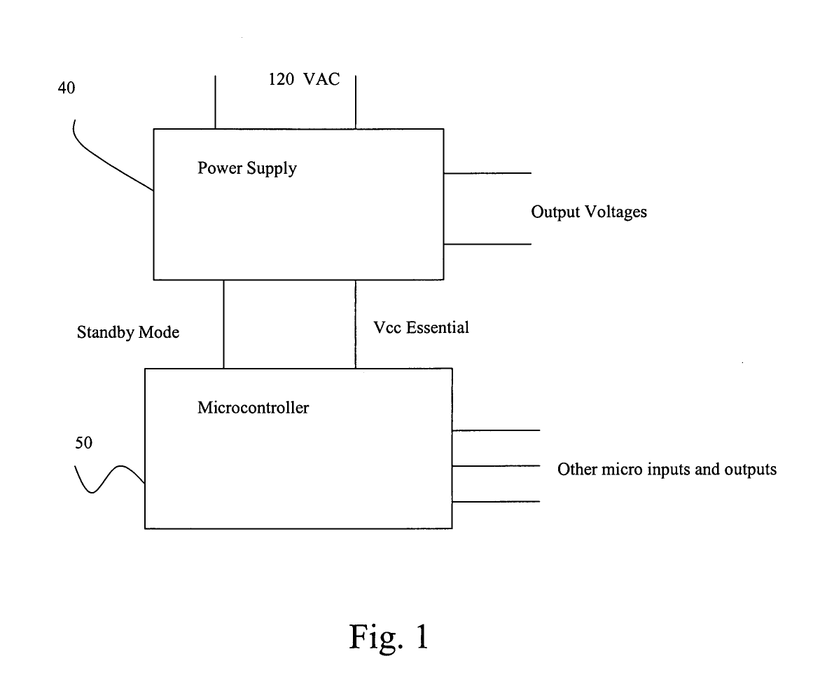

FIG. 1 is a high-level block diagram that illustrates a one embodiment of a reduced power circuit 10 typically comprising a switching mode power supply circuit 40 coupled to a microcontroller 50. The microcontroller 50 may be dedicated to controlling the switching mode power supply, or may be used for other functions, e.g., controlling operation of a kitchen appliance or processing user inputs or other control input signals, as well as controlling the switching mode power supply. Further, the microcontroller may be embodied in various forms, using discrete, fixed-logic analog and/or digital electronics, microprocessors, or other components. This configuration of the switching mode power supply and microcontroller 50 is well known to one of ordinary skill in the art. Other circuitry (not shown) may also receive power from the switching mode power supply.

Additional information about the configuration and interaction between a switch mode power supply and a microcontroller is provided in the Power Integrations, Inc. document entitled, TOP232-234, TOPSwitch®-FXFamily, Design Flexible, EcoSmart®, Integrated Off-line Switcher, which is incorporated by reference. FIG. 27 of the attached Power Integrations, Inc. document illustrates using a microprocessor/controller to turn the TOPSwitch-FX power supply off. However, the aforementioned document relies on an external or other system components to activate the system, since once the power is removed the controller is no longer able to activate itself or the power supply.

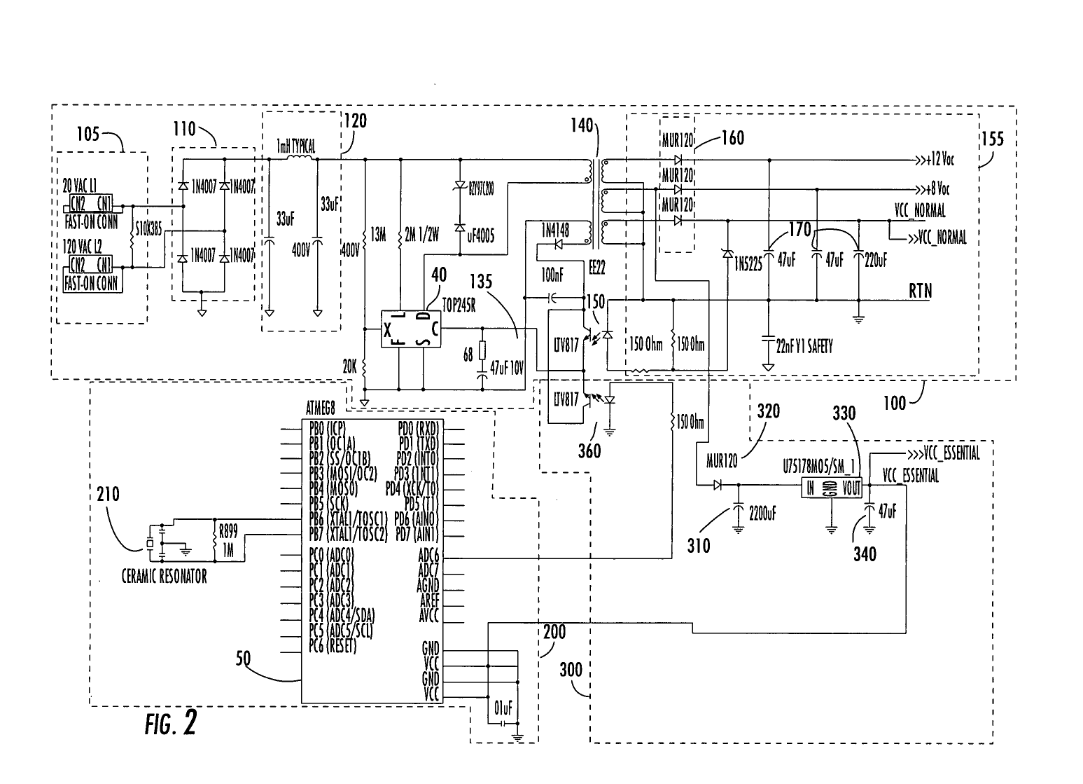

FIG. 2 is a diagram of an embodiment of a reduced power consumption circuit 10 in accordance with the present invention. The circuit in this illustration comprises a switching mode power supply circuit 100, a microcontroller circuit 200 and a standby control circuit 300. The switching mode power supply circuit 100 has an input section 105 for connection to a line voltage, typically comprising a 240 volt or 120 volt alternating current (VAC) source, such as that typically used to power household appliances or electronic devices. Although illustrated using 120 VAC, the principles of the present invention would apply to other line voltages, such as 110 volts, 220 volts, or any other voltage, as well as applying to systems operating at 50 Hertz.

The power supply circuit also includes a full wave bridge rectifier 110, an EMI filter 120, and a switching mode power supply 40, shown in a fly-back configuration. The power supply circuit also includes a switching mode power supply controller circuit 135, a transformer 140, feedback control 150, and an output section 155, which includes half-wave rectifiers 160 and output filter capacitors 170. In the circuit illustrated in FIG. 2, the microcontroller circuit 200 includes a microcontroller 50 and a ceramic oscillator 210.

In operation, the power from the switching mode power supply 100 charges reserve power capacitor 310 through rectifier diode 320. The reserve power capacitor 310 provides standby power to the microcontroller 50 through regulator 330 and filter capacitors 340. Although the reserve power capacitor is disclosed as a 2200 μƒ capacitor, other values may be used as long as sufficient reserve power as required is provided to the microcontroller. The microcontroller 50 then asserts a control signal to the optoisolator 360 to cause a shutdown of the switching mode power supply 40 and associated circuitry. A more detailed description of the remote switching technique for using a microcontroller to turn a switch mode power supply off and on can be found in the attached Power Integrations, Inc. document entitled, TOP232-234, TOPSwitch®-FX Family, Design Flexible, EcoSmart®, Integrated Off-line Switcher.

During shutdown, the microcontroller 50 is maintained through the charge in capacitor 310. Further, during shutdown, the microcontroller may be in a ‘sleep’ mode or state, in which it executes certain instructions so as to minimize power consumptions. In alternative embodiments, a watchdog timer function may notify the microcontroller to “wake up” at certain internals. Regardless of how the microcontroller asserts the control signal at various time intervals, the control signal is sent from the microcontroller, typically via the control circuit to the switching mode power supply 40 and the system resumes its normal function using normal power. The control signal, known as a standby control signal, may be normally low or normally high.

In other embodiments, the microcontroller may activate the power supply to operate based on various criteria. For example, the microcontroller may receive inputs from other circuits, such as from devices detecting the presence of light or movement (e.g., a photocell or photodiode detecting natural or artificial light or an infrared or motion detector). The system may deactivate the power supply when no light or motion is detected, or alternatively, activate the system upon detecting the presence of light or motion. Other systems may incorporate an explicit “low power state” or “wake up” input that is activated or indicated by the user. For example, a microcontroller may deactivate the power supply and associated display panel on an appliance based in part on the lack of any user input. In other embodiments, the deactivation could be based in part on a timer detecting the absence of any user input or even the absence of the person (e.g., an infrared detector detects the person has walked away). Upon detecting user input signifying activation of the appliance (which could involve the user activating a specific or any switch, or other components detecting the nearby presence of the user via the aforementioned motion detector), the microcontroller would monitor this input and activate the power supply, thereby activating the display panel to the user.

In one embodiment, during this period of normal function, the system samples any user inputs, input signals, or other system inputs. If, for example, a user input is detected indicating a user intended activation, the microcontroller can change the status or mode of operation of the system by altering the standby control signal and thus place the switching power supply in an active state. During the active state, the switching power supply recharges the capacitor.

The timing and determination of the standby control signal may be accomplished using software executing in the microcontroller, external circuitry, or other combination of hardware/software components asserting and releasing the standby control signal in order to shutdown the switching power system as desired. Alternatively, instead of a single binary control signal, those skilled in the art realize that various configurations of flip-flops and other circuitry can be used to generate separate activation and deactivation signals.

In one embodiment, the microcontroller's 50 control of the switch mode power supply 40 is timed in such a way that the user will not notice a delay in the system between input samplings. In one embodiment, for example, the microcontroller 40 causes the switching mode power supply 40 to “wake up” and provide power approximately every 70-80 microseconds. The power charges the reserve power capacitor as well as any other circuits which previously did not have power. During this period of activation, which, in one embodiment may typically last anywhere from approximately two to ten milliseconds, the system checks any user inputs or system inputs, and changes the mode of operation as necessary. The power from the switching mode power supply 40 recharges the capacitor 310 so that power to the microcontroller 50 is maintained during the next shutdown cycle. If a user input is detected, the system goes into normal by changing the standby control signal to indicate active or normal operation. If a user input (or other input) is not detected, the microcontroller 50 sends another standby control signal to the optoisolator 360 and the system shuts back down, thereby placing the power supply in a inactive or off state. Further, the microcontroller may determine for other reasons whether to inhibit the control signal. For example, based on a determination of resources, the type of input, purpose of the software being executed, or other systems actions being performed, the microcontroller may determine to activate the switching power supply on a continuous basis, at least until the microcontroller determines otherwise.

By periodically shutting down various components of the systems for short periods, it is possible to significantly lower the average power consumption of the system, and at the same time monitoring various inputs or performing other functions with sufficient frequency that the user is unaware of any delay that might occur while the system is shutdown.

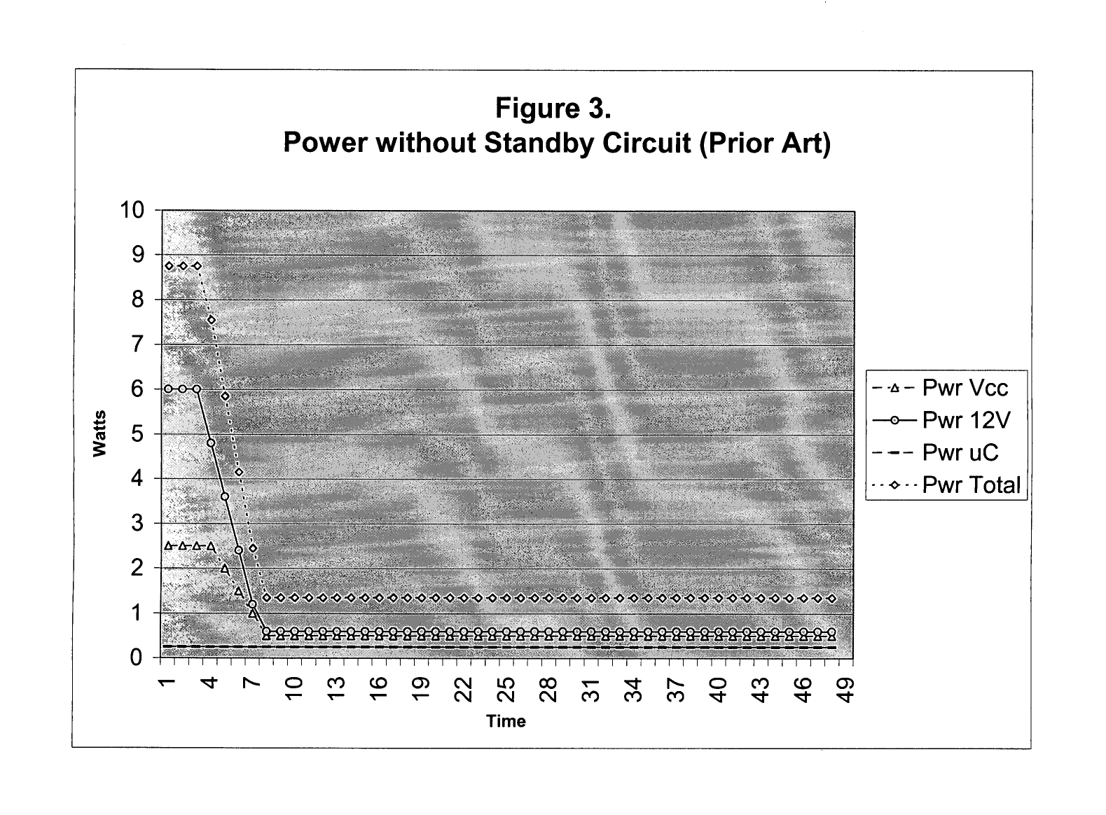

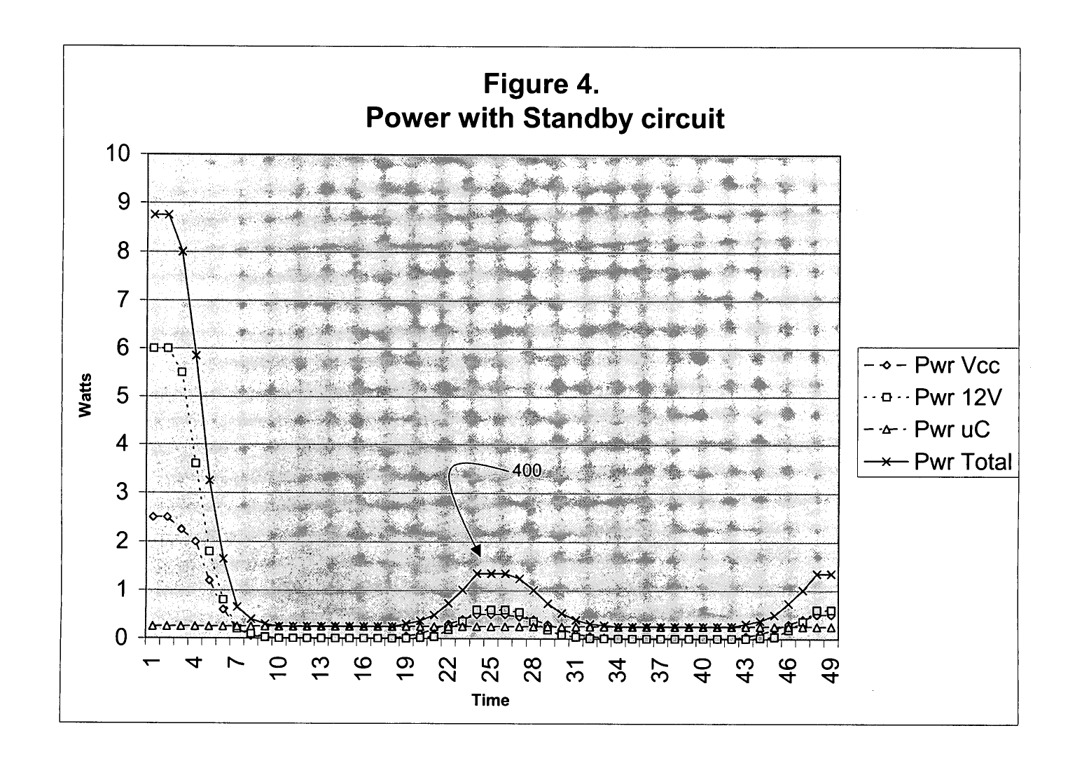

FIGS. 3 and 4 are graphs of system power consumption that show the power savings afforded when the reduced power consumption circuit of the present invention is used. FIG. 3 is a graph of the prior art showing the rate of power consumption of a typical control circuit. As can be seen, the total power consumption of the system is approximately 9 watts under normal operating conditions and drops to an average of 1.35 watts during standby or idle periods. FIG. 4 shows the power consumption of a similar control circuit that employs the reduced power consumption techniques described herein to cyclically shutdown the non-essential components of the control circuit. The graph of FIG. 4 shows that the average power consumed by the system during standby or idle periods drops to approximately slightly less than 0.5 watts. FIG. 4 illustrates a “blip” 400 at about 25 milliseconds at which time the microcontroller activated the power supply by asserting the control signal, causing an increase in the total power consumption to about 1.5 watts. After the control signal is asserted, the microcontroller releases the signal, deactivating the power supply, after which time the total power reverts to the lower average value of around slightly less than 0.5 Watts.

One of ordinary skill in the art will recognize that one benefit of the present invention is that the reduction is power consumption during standby is achieved without the use of relays and additional power supplies and separate microcontrollers configured to control the relay. In one embodiment, the only circuit components that are added to the traditional control system to achieve the low power consumption in standby mode are the optoisolator 360, a resistor 361, and a capacitor 310 as shown in FIG. 2, each of which are standard and relatively inexpensive circuit components well known in the art. In the embodiment shown in FIG. 2, the opto-isolator 360 selectively isolates the power from the switch mode power supply to the lower voltage microcontroller.

One of ordinary skill in the art will also recognize that in alternative embodiments, the function of the optoisolator 360 can be performed by other known components such as, for example, a transistor. The transistor, while cheaper than the optoisolator, typically does not provide as much isolation between the low and high power sides of the circuit. However, use of a transistor reduces the power consumption while in standby mode. In another embodiment, a field-effect-transistor (FET) can be used that significantly reduces the current drawn compared to an opto-isolator from around 20 milli-amps to several micro-amps. Incorporation of a FET rather than an opto-isolater would further reduce the standby power consumption from the 0.5 Watts illustrated in FIG. 4.

A low power consumption standby circuit that uses the techniques described above can also be achieved with a transistor used in what is commonly referred to as a hot power supply with a “buck” configuration of the switch mode power supply 130. A more detailed description of the this configuration is provided in the Power Integrations, Inc. document entitled, Design Idea DI-ll, TinySwitch®II, Buck Converter, which is attached hereto and hereby incorporated by reference.

It should be emphasized that the above-described embodiments of the present invention are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

1. A system for conserving power comprising:
a switching power supply having an input section receiving a line voltage, the switching power supply further configured to receive a first control signal placing the switching power supply into an off state, the switching power supply further comprising an output section providing a first output and a second output, the first output providing a capacitive reserve power when the switching power system is in the off state;
a control circuit receiving a second control signal and generating the first control signal in response to the second control signal; and
a microcontroller providing the second control signal to the control circuit when the switching power supply is in the off state, the microcontroller further receiving the first output from the switching power supply.

2. The system of claim 1 wherein the switching power supply is further configured to place the switching power supply into an on state based on the second standby control signal.

3. The system of claim 1 wherein the control circuit comprises an opto-isolator.

4. The system of claim 1 wherein the control circuit comprises a transistor.

5. The system of claim 4 wherein the transistor is a FET.

6. The system of claim 1 wherein the second output is at a first predefined voltage when the power supply is in an on state and at a second predefined voltage when in the off state.

7. The system of claim 1 wherein the microcontroller is configured to generate a periodic second control signal.

8. The system of claim 1 wherein the switching power supply, the control circuit, and the microcontroller are incorporated into a kitchen appliance.

9. The system of claim 1 wherein the capacitance reserve provides sufficient power to power the microcontroller for at least 10 micro seconds.

10. A power supply comprising an input section for receiving an input line voltage and an output section for supplying a first output at a DC voltage and a second output at the DC voltage, wherein the first output is provided to a capacitor providing reserve capacitance power to a controlling device, the controlling device providing a control signal when the power supply is in a standby mode, whereby the control signal activates the power supply thereby recharging the capacitor.

11. A power supply of claim 10, wherein the power supply is a switching mode power supply used in a household appliance or a consumer electronics device.

12. A power supply of claim 10, where the supply power system is a switching mode power supply and the controlling device is a microcontroller.

13. A power supply of claim 12 further comprising an opto-islolator receiving a first signal from the microcontroller and generating the control signal in response to the first signal.

14. A power conserving circuit comprising:
a processor receiving a DC supply voltage, the processor adapted to execute software detecting the presence of input from a user and generating a control signal in response thereto; and
a switching power supply capable of receiving an AC line voltage and providing the DC supply voltage on a first output to a reserve capacitor while in a shutdown state, the reserve capacitor providing power to the processor, the switching power supply capable of receiving the control signal, changing to an on state, providing the DC supply voltage on the first output, charging the reserve capacitor, and generating a second output of the same DC supply voltage.

15. The system of claim 14 wherein the processor is further adapted to generate the control signal after processing the input from the user.

16. A method of conserving power in a circuit, comprising:
using a capacitor to provide reserve power to a microcontroller;
using the microcontroller to monitor a user input on a control of a consumer appliance;
detecting the user input on the control of the consumer appliance;
generating a first instance of a control signal from the microcontroller to a switching power supply;
activating the switching power supply, the switching power supply operatively connected to an AC line voltage and providing power to a reserve power capacitor;
charging the reserve power capacitor to provide the reserve power; and
providing power to a second circuit from the switching power supply.

17. The method of claim 16 further comprising the steps of:
determining in the microcontroller that the second circuit does not require power;
generating a second instance of a control signal from the microcontroller to the switching power supply; and
changing the state of the switching power supply to standby in response to the control signal.

18. The method of claim 17 further comprising the step of:
generating a second instance of the control signal from the microcontroller to the switching power supply.

19. A method of conserving power in a circuit, comprising:
providing capacitance reserve power to a microcontroller from a switching power supply wherein the switching power supply is deactivated;
determining a need in the microcontroller to generate a control signal;
generating a first instance of the control signal from the microcontroller to the switching power supply;
turning on the switching power supply, the switching power supply operatively connected to an AC line voltage;
charging a capacitor providing the capacitance reserve power;
providing power from the switching power supply to the microcontroller using the capacitor;
setting a timer in the microcontroller;
generating a control signal from the microcontroller to the switching power supply after the expiry of the timer; and
turning off the switching power supply based on the control signal.

20. The method of claim 19 wherein the timer is less than 10 milliseconds.

21. The method of claim 19 wherein the power provided by the capacitor to the microcontroller is less than 10 milliseconds.

22. A method of conserving power comprising:
providing power to a microcontroller from a switching power supply wherein the switching power supply obtains power from a line source;
monitoring an input to the microcontroller used in part to determine whether to generate a low-power control signal;
determining a need in the microcontroller to generate a control signal;
generating a first instance of the low power control signal from the microcontroller to the switching power supply;
deactivating the switching power supply based on the low power control signal;
providing capacitance reserve power to the microcontroller from a switching power supply wherein the switching power supply is deactivated;
setting a timer in the microcontroller;
generating a control signal from the microcontroller to the switching power supply after the expiry of the timer; and turning off the switching power supply based on the control signal.

23. The method of claim 22 where determining a need in the microcontroller to generate a control signal is based on a second timer.

24. The method of claim 22 where determining a need in the microcontroller to generate a control signal is based on detecting the absence of ambient light.

25. The method of claim 22 where determining a need in the microcontroller to generate a control signal is based on a user input.

26. The method of claim 22 wherein the input to the microcontroller used in part to determine whether to generate a low-power control signal is determined by the user activating an input switch.

27. The method of claim 22 wherein the input to the microcontroller used in part to determine whether to generate a low-power control signal is determined by one from the group of an infrared detector, a photocell, and a photodiode.
